(19) United States
(12) Patent Application Publication
(10) Pub. No.: US 2010/0179993 A1
(43) Pub. Date: Jul. 15, 2010

(54) EMAIL PRODUCTIVITY MONITORING FACILITY

(75) Inventors: Megan A. Beynon, Surrey (GB); Conor P. Beverland, Chicago, IL (US); Joseph K. Chacko, Sheffield (GB); David G. Screen, Hampshire (GB)

Correspondence Address: IBM Corp. ( Raleigh), c/o Nelson and Nelson, 2984 E. Evergreen Ave., Salt Lake City, UT, 84109, US

(73) Assignee: INTERNATIONAL BUSINESS MACHINES CORPORATION, Armonk, NY (US)

(21) Appl. No.: 12/352,160

(22) Filed: Jan. 12, 2009

(51) Int. Cl. G06F 15/16; G06F 15/173

(52) U.S. Cl. 709/206; 709/224

(57) ABSTRACT

A method is presented for monitoring electronic communications to facilitate productivity. The method may include detecting the opening of an electronic message on a computer and storing a start time corresponding to the opening. Metadata associated with the electronic message may be recorded. Such metadata may include, for example, a recipient, a sender, a subject, and a number of words typed. The method may further detect the closing of the electronic message, and may store an end time corresponding to the closing. Efficiency metrics associated with the message may be calculated based on the start time, the end time, and the metadata. Efficiency metrics may include, for example, total time spent, total word count, and number of words typed per minute. A report reflecting the metadata and the efficiency metrics may be generated.

### BACKGROUND

1. Field of the Invention

The invention relates to email management. Particularly, the invention relates to monitoring email usage patterns to facilitate productivity.

2. Description of the Related Art

Email and other types of electronic communication have emerged as necessary mainstays of business and personal relationships alike. Such modes of communication are increasingly encouraged in the workplace, as they enable faster and more effective interpersonal communication, thereby furthering efficiency and productivity.

Despite these advantages, however, the instantaneous and varied nature of email tends to distract even the most focused individuals from accomplishing more menial tasks. Further, as email has become the norm across most industries, the sheer volume of email received and requiring attention on a daily basis often intrudes into time that should be spent on other matters.

Often, the level of distraction and amount of time spent reading and responding to email is not fully realized. This ignorance may compound the problem, as one may subjectively feel that work is being accomplished when in reality constant interruptions from a barrage of email may be eating up significant portions of the day. Ironically, work productivity may thus suffer as a direct result of the very technological advance designed to increase work-related efficiencies.

From the foregoing discussion, it should be apparent that a need exists for a tool for monitoring email and other electronic communications to facilitate personal and work-related productivity. Beneficially, such a tool would provide particular information to a user regarding email-related patterns, such as time spent reading or responding to various types of email, email sent by a particular sender, email relating to a particular subject, and the like. Such a tool is disclosed and claimed herein.

### SUMMARY OF THE INVENTION

The present invention has been developed in response to the present state of the art, and in particular, in response to the problems and needs in the art that have not been fully met by current productivity tools. Accordingly, the present invention has been developed to provide a tool for monitoring electronic communications that overcomes many or all of the above-discussed shortcomings in the art.

In one embodiment, a method for monitoring electronic communications to facilitate productivity includes detecting the opening of an electronic message on a computer and storing a start time corresponding to the opening. Metadata associated with the electronic message may be recorded. Such metadata may include, for example, a recipient, a sender, a subject, and a number of words typed.

The method may further detect the closing of the electronic message, and may store an end time corresponding to the closing. Efficiency metrics associated with the message may be calculated based on the start time, the end time, and the metadata. Efficiency metrics may include, for example, total time spent, total word count, and number of words typed per minute. A report reflecting the metadata and the efficiency metrics may be generated.

A corresponding apparatus is also disclosed and claimed herein.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a flow chart illustrating a method for monitoring electronic communications to facilitate productivity in accordance with certain embodiments of the invention; and

FIG. 2 is a block diagram illustrating modules for monitoring electronic communications in accordance with embodiments of the invention.

### DETAILED DESCRIPTION OF THE INVENTION

It will be readily understood that the components of the embodiments of the invention, as generally described and illustrated in the Figures herein, could be arranged and designed in a wide variety of different configurations. Thus, the following more detailed description of the embodiments of the invention, as represented in the Figures, is not intended to limit the scope of the claims, but is merely representative of certain examples of presently contemplated embodiments in accordance with the invention. The presently described embodiments will be best understood by reference to the drawings, wherein like parts are designated by like numerals throughout.

As will be appreciated by one skilled in the art, embodiments of the invention may be embodied as an apparatus, method, or computer program product. Furthermore, the present invention may take the form of an entirely hardware embodiment, an entirely software embodiment (including firmware, resident software, micro-code, etc.) or an embodiment combining software and hardware elements. Hardware and/or software elements provided to perform various tasks may be generally referred to herein as “modules.” Furthermore, the present invention may take the form of a computer program product embodied in any tangible medium of expression having computer-usable program code embodied in the medium.

Any combination of one or more computer-usable or computer-readable medium(s) may be utilised. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (“RAM”), a read-only memory (“ROM”), an erasable programmable read-only memory (“EPROM” or Flash memory), an optical fiber, a portable compact disc read-only memory (“CDROM”), an optical storage device, transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments of the present invention teach an apparatus and method to monitor electronic communications to facilitate productivity. Further, certain embodiments may alert a user to demonstrated electronic communication patterns to enable the user to make educated adjustments to such practices, thereby promoting individual productivity.

As used herein, the terms “electronic communication” or “electronic message” refer to any form of person-to-person communication sent from one computer to another over a network, including electronic mail (“email”), instant messaging, text messaging, and the like. The term “efficiency metrics” refers generally to data and measurements derived from electronic communications.

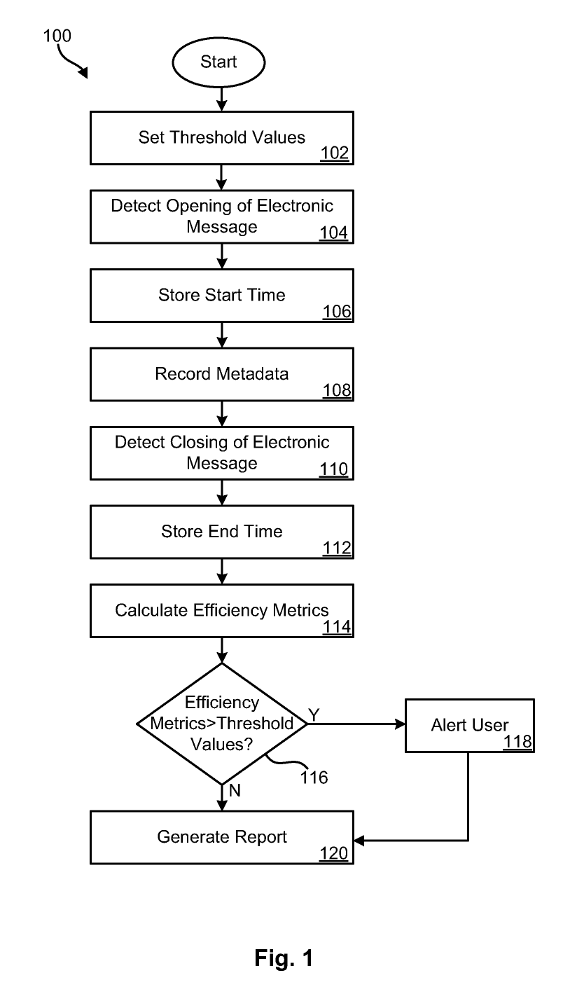

FIG. 1 illustrates a method 100 for monitoring electronic communications to facilitate productivity in accordance with certain embodiments of the invention. In some embodiments, certain threshold values may be initially set 102 for electronic communications. Threshold values may be set by a user, or may be predefined by an administrator or other program or individual. Such threshold values may include, for example, an amount of time spent composing an electronic message, an amount of time reading an electronic message, a number of words typed per minute, or the like. In some embodiments, threshold values may be more narrowly defined by taking into account additional data, such as an amount of time spent per discussion thread (by linking the subject header information), a number of times an electronic message may be returned to before completion, an amount of time spent reading email sent to a large distribution list, and the like.

Monitoring electronic communications to facilitate productivity may then proceed by detecting 104 opening of an electronic message and storing 106 a start time associated with the opening. Detecting 104 the opening an electronic message may include commencing drafting a new electronic message, commencing responding to a received message, commencing reading a received message, or the like.

In certain embodiments, metadata associated with the electronic message may be recorded 108 from the header or other section of the electronic message. For example, metadata may include a recipient, a sender, a subject, keywords, or other information associated with the electronic message.

The method 100 may detect 110 closing of the electronic message, and may store 112 an end time associated with the closing. Closing of the electronic message may include sending, exiting, or minimizing the electronic message. In some embodiments, closing may also include opening another window or program such that the electronic message is thereby relegated to the background of a computer viewing area.

Based on the start time, the end time, and the metadata, efficiency metrics for the electronic message may be calculated 114. Efficiency metrics may include a total time spent per electronic message, a total word count for the message, a number of words typed per minute, and the like. In some embodiments, a total time spent may be calculated by subtracting the start time from the end time, and cumulating time intervals spent reading or composing the same electronic message.

Efficiency metrics may also include measures of productivity encompassing more than one electronic message. In certain embodiments, for example, efficiency metrics may include time spent composing electronic messages per recipient, time spent reading electronic messages per sender, time spent per organization, a total time spent composing new electronic messages, a total time spent responding to received electronic messages, and the like. In certain embodiments, keywords featured in the subject line of messages having a longest total time spent and keywords featured in the subject of messages having a shortest time spent may also be determined and stored.

Efficiency metrics may include efficiency ratings that take into account a final word count for the message, as well as a number of words typed in the process of creating the message, since often text is written and later deleted as edits are made to the message. In some embodiments, for example, an efficiency rating may be calculated based on a final length of the message and words typed per minute. Another efficiency rating may be determined based on the length of the message during preparation relative to a final word count for the message; in other words, total words sent divided by total words typed.

In certain embodiments, efficiency metrics thus obtained may be compared 116 to the threshold values initially set 102. If an efficiency metric value exceeds a threshold value previously set, a user may be alerted 118, thereby enabling the user to take appropriate steps to remedy the problem. In some embodiments, the user may be notified 118 immediately via electronic messaging, for example. In other embodiments, the user may be alerted 118 at predetermined intervals, or at any other predetermined or dynamically determined time.

In one embodiment, for example, a user may desire to spend no longer than thirty minutes per day reading electronic messages sent to large distribution lists. This parameter may be included in the threshold values initially set 102. The user's electronic communications may then be monitored in accordance with the invention. Upon reaching the thirty-minute threshold value for reading electronic messages sent to large distribution lists, the user may be alerted 118 via electronic notification, for example. In this manner, the user may be alerted to undesirable electronic communication practices and given an opportunity to self-correct. Embodiments of the invention thus provide a valuable service to users by facilitating a user's ability to maximize productivity while exploiting the benefits of electronic communication technology.

If efficiency metric values do not exceed 116 predetermined threshold values, a report may be generated 120 to identify pertinent features and patterns of a user's electronic-communication-related behavior. Likewise, a report may be generated 120 once a user has been notified 118 that a threshold value has been met or exceeded.

Report contents may include any or all of the metadata previously collected and efficiency metrics calculated. As previously discussed, the metadata and efficiency metrics may be specific to each electronic message, as defined by a start time and an end time. The report may provide this specific information, as well as providing general information regarding all electronic messages monitored during a particular period of time. For example, the report may indicate the amount of time spent reading emails from a particular sender or department, composing emails to a particular recipient or department, or reading or composing emails for all senders or departments. The period of time covered by a report may be predetermined or dynamically set.

In some embodiments, the report may graphically display information in the form of a graph or pie chart. The report may also list metadata and efficiency metrics gathered, and statistical information related to each. In one embodiment, for example, the report may include a graph showing a volume of electronic messages at particular times during the day, and efficiency metrics associated with each time. Based on this report, the user may identify certain times of the day or week that he is most efficient, and may configure the present invention to alert him when he commences electronic communications during these times.

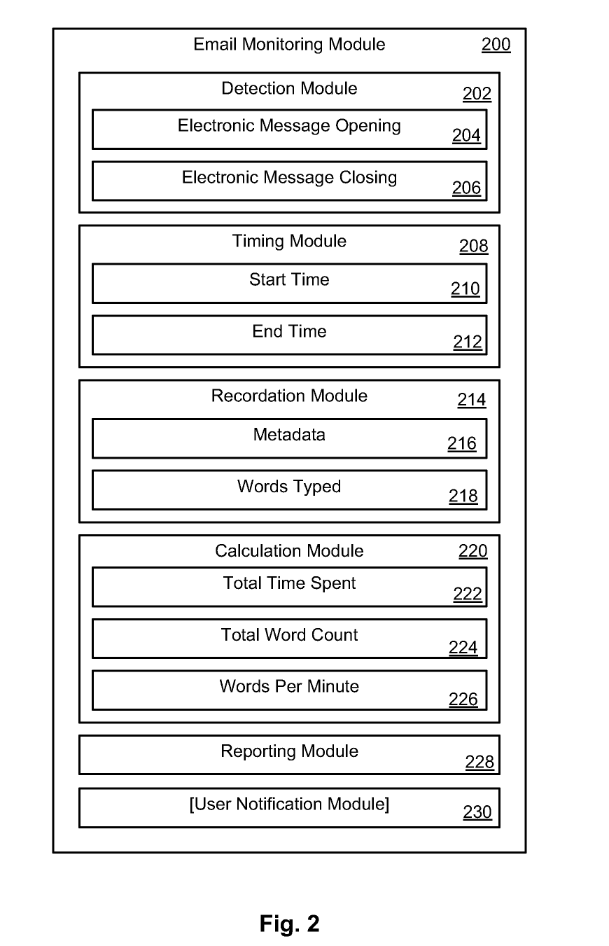

Referring now to FIG. 2, an apparatus to monitor electronic communications to facilitate productivity in accordance with the invention may include an email monitoring module 200 having a detection module 202, a timing module 208, a recordation module 214, a calculation module 220, and a reporting module 228.

The detection module 202 may detect opening 204 and closing 206 of an electronic message on a computer. The electronic message may be a new electronic message, a received electronic message, a response to a received message, or any other type of electronic message known to those in the art. As previously discussed, closing 206 the electronic message may include sending, exiting, or minimizing the electronic message displayed in a computer viewing area. Alternatively, closing 206 the electronic message may include opening another program or window such that the electronic message is at least partially blocked from the viewing area.

The timing module 208 may store a start time 210 corresponding to the opening 204 of the electronic message, and an end time 212 corresponding to the closing 206 of the message.

The recordation module 214 may record data and metadata 216 associated with the electronic message. Metadata 216 may include, for example, a message recipient, a message sender, a subject of the message, a number of words typed 218, and any other such data or metadata known to those in the art. The calculation module 220 may or may not utilize the metadata 216 to determine efficiency metrics such as total time spent 222, a total word count 224, a number of words per minute 226, and the like. The calculation module 220 may further identify keywords featured in the subject line of messages that took the longest or shortest amount of time, or otherwise deemed significant.

The reporting module 228 may generate a report for the user that provides at least a portion of the metadata 216 and efficiency metrics in an easy-to-understand format. For example, the report may include one or more graphs, pie charts, or other visual representations to facilitate data comprehension. The contents of the report may be specified by the user or another individual or program at setup, or at any other time prior to report generation.

In some embodiments, the reporting module 228 may generate a report showing an amount of time spent per recipient, a time spent per organization, a time spent creating new electronic messages, keywords featured in the subject of messages that took a longest and shortest amount of time, efficiency ratings, and a graph showing a volume of electronic messages received at each time of the day and efficiencies during the day. As previously mentioned, efficiency ratings maybe derived from, for example, a final word count and words per minute for a particular electronic message, and/or words sent relative to words typed. The contents of the report may thus alert a user to email communication practices that may be having a deleterious effect on work or personal productivity, thereby facilitating the user's ability to counteract such behavior.

In certain embodiments, an email monitoring module 200 in accordance with the invention may further include a user notification module 230. The user notification module 230 may enable a user to establish threshold values deemed significant to the user's electronic communication practices. In some embodiments, for example, the user may establish a maximum time for responding to messages received from a particular sender. In other embodiments, the user may establish a maximum number of times that a same message may be returned to throughout the day.

Once such threshold values have been established, the user notification module 230 may alert a user via instant messaging, for example, if an established threshold value has been met or exceeded. Alternatively, the user notification module 230 may be configured to provide such information to the user at established times of the day, at predetermined intervals of time, or at any other time desired by the user. Likewise, the user notification module 230 may provide such information via instant messaging, email messaging, text messaging, voice messaging, and/or may include such information in the report generated by the reporting module 228. In this manner, the present invention may be customized to provide the desired amount of support and information in a way that is deemed most helpful to a particular user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for monitoring electronic communications to facilitate productivity, the method comprising:
detecting the opening of an electronic message on a computer;
storing a start time corresponding to the opening;
recording metadata associated with the electronic message, the metadata comprising at least one of a recipient, a sender, a subject, and a number of words typed;
detecting the closing of the electronic message;
storing an end time corresponding to the closing;
calculating efficiency metrics associated with the electronic message based on the start time, the end time, and the metadata, the efficiency metrics comprising at least one of a total time spent, a total word count, and a number of words typed per minute; and
generating a report reflecting the metadata and the efficiency metrics.

2. The method of claim 1, wherein opening of the electronic message comprises one of commencing a new electronic message, opening a received electronic message, and commencing responding to a received electronic message.

3. The method of claim 1, wherein closing of the electronic message comprises one of sending a new electronic message, exiting a received electronic message, minimizing an electronic message, and causing an electronic message to be relegated to a background of a computer viewing area.

4. The method of claim 1, further comprising setting at least one threshold value corresponding to an efficiency metric.

5. The method of claim 5, further comprising alerting a user in the event the efficiency metric exceeds the threshold value.

6. An apparatus for monitoring electronic communications to facilitate productivity, the apparatus comprising:
a detection module to detect the opening and closing of an electronic message on a computer;
a timing module to store a start time corresponding to the opening and an end time corresponding to the closing;
a recordation module to record metadata associated with the electronic message, the metadata comprising at least one of a recipient, a sender, a subject, and a number of words typed;
a calculation module to calculate efficiency metrics associated with the electronic message based on the start time, the end time, and the metadata, the efficiency metrics comprising at least one of a total time spent, a total word count, and a number of words typed per minute; and
a reporting module to generate a report reflecting the metadata and the efficiency metrics.

7. The apparatus of claim 6, wherein opening of the electronic message comprises one of commencing a new electronic message, opening a received electronic message, and commencing responding to a received electronic message.

8. The apparatus of claim 6, wherein closing of the electronic message comprises one of sending a new electronic message, exiting a received electronic message, minimizing an electronic message, and causing an electronic message to be relegated to a background of a computer viewing area.

9. The apparatus of claim 6, further comprising a user notification module to set at least one threshold value corresponding to an efficiency metric and alert a user in the event the efficiency metric exceeds the threshold value.
